(19) United States
(12) Patent Application Publication
(10) Pub. No.: US 2010/0331531 A1
(43) Pub. Date: Dec. 30, 2010

(54) METHODS FOR ESTERIFYING LIGNOCELLULOSIC MATERIAL

(75) Inventor: John Peter Mykytka, Kingsport, TN (US)

Correspondence Address: WILLIAM K. MCGREEVEY;EASTMAN CHEMICAL COMPANY, 100 NORTH EASTMAN ROAD, KINGSPORT, TN, 37660-5075, US

(73) Assignee: Eastman Chemical Company, Kingsport, TN (US)

(21) Appl. No.: 12/817,767

(22) Filed: Jun. 17, 2010

Related U.S. Application Data
(60) Provisional application No. 61/220,428, filed on Jun. 25, 2009.

(51) Int. Cl. C07G 1/00

(52) U.S. Cl. 530/501; 530/504; 530/500; 530/507

(57) ABSTRACT

Methods of making esterified lignocellulosic materials and resulting compositions and articles are disclosed.

### CROSS-REFERENCE TO RELATED APPLICATION

This application claims priority to U.S. Provisional Application Ser. No. 61/220,428, filed Jun. 25, 2009.

### BACKGROUND OF THE INVENTION

Esterified lignocellulosic materials such as acetylated wood can be desirable in some applications because of their greater dimensional stability than untreated wood and other qualities. These advantages exist for both esterified solid wood materials such as acetylated boards and lumber and fiberized lignocellulosic materials that are acetylated then used in composite materials. However, there remains a continuing need to improve the favorable properties of these materials.

### SUMMARY OF THE INVENTION

Some embodiments of the invention therefore provide a method of acetylating lignocellulosic material, including:

(a) impregnating lignocellulosic material with a liquid that contains acetic acid;

(b) contacting the impregnated lignocellulosic material from (a) with a vapor stream that contains acetic acid under conditions sufficient to acetylate at least some of the lignocellulosic material.

In some embodiments, the acetylation methods of the invention may further include:

(c) impregnating the contacted lignocellulosic material from (b) with a liquid that contains acetic anhydride; and

(d) contacting the impregnated lignocellulosic material in (c) with a vapor stream containing acetic anhydride, acetic acid or both, under conditions sufficient to increase the acetylation of the lignocellulosic material.

The invention further provides acetylated lignocellulosic materials made by the methods of the invention.

### DETAILED DESCRIPTION

The invention provides methods for acetylating lignocellulosic materials. The invention further provides acetylated lignocellulosic materials and compositions and articles made using acetylated lignocellulosic materials.

### Lignocellulosic Material

Lignocellulosic material includes any material containing cellulose and lignin (and optionally other materials such as hemicelluloses). Some examples include wood, bark, kenaf, hemp, sisal, jute, crop straws, nutshells, coconut husks, grass and grain husks and stalks, corn stover, bagasse, conifer and hardwood barks, corn cobs, other crop residuals and any combination thereof.

In some embodiments, the lignocellulosic material is wood. Wood may be selected from any species of hardwood or softwood. In some embodiments the wood is a softwood. In some embodiments the wood is selected from pine, fir, spruce, poplar, oak, maple and beech. In some embodiments the wood is a hardwood. In some embodiments, the wood is selected from red oak, red maple, German beech, and Pacific albus. In some embodiments, the wood is a pine species. In some embodiments, the pine species is selected from Loblolly Pine, Longleaf Pine, Shortleaf Pine, Slash Pine, Radiata Pine and Scots Pine. In some embodiments, the wood is Radiata Pine. In some embodiments, the wood is from one or more of the four species commercially referred to as “Southern Yellow Pine” (Longleaf Pine, Shortleaf Pine, Slash Pine, Loblolly Pine). In some embodiments, the wood is selected from Longleaf Pine, Shortleaf Pine, and Loblolly Pine. In some embodiments, the wood is Loblolly Pine.

The lignocellulosic material may be in any form. Examples include shredded material (e.g. shredded wood), fiberized material (e.g. fiberized wood), wood flour, chips, particles, excelsior, flakes, strands, wood particles and materials such as trees, tree trunks or limbs, debarked tree trunks or limbs, boards, veneers, planks, squared timber, beams or profiles, and other cut lumber of any dimension.

In some embodiments, the lignocellulosic material is wood. Wood may be selected from any species of hardwood or softwood. In some embodiments the wood is a softwood. In some embodiments the wood is selected from pine, fir, spruce, poplar, oak, maple and beech. In some embodiments the wood is a hardwood. In some embodiments, the wood is selected from red oak, red maple, German beech, and Pacific albus. In some embodiments, the wood is a pine species. In some embodiments, the pine species is selected from Loblolly Pine, Longleaf Pine, Shortleaf Pine, Slash Pine, Radiata Pine and Scots Pine. In some embodiments, the wood is Radiata Pine. In some embodiments, the wood is from one or more of the four species commercially referred to as “Southern Yellow Pine” (Longleaf Pine, Shortleaf Pine, Slash Pine, Loblolly Pine). In some embodiments, the wood is selected from Longleaf Pine, Shortleaf Pine, and Loblolly Pine. In some embodiments, the wood is Loblolly Pine.

The lignocellulosic material may be in any form. Examples include shredded material (e.g. shredded wood), fiberized material (e.g. fiberized wood), wood flour, chips, particles, excelsior, flakes, strands, wood particles and materials such as trees, tree trunks or limbs, debarked tree trunks or limbs, boards, veneers, planks, squared timber, beams or profiles, and other cut lumber of any dimension.

In some embodiments, the lignocellulosic material is solid wood. As used throughout this application, “solid wood” shall refer to wood that measures at least about ten centimeters in at least one dimension but is otherwise of any dimension, e.g. lumber having nominal dimensions such as 2 feet×2 feet by 4 feet, 2 feet×2 feet by 6 feet 1 foot×1 foot by 6 feet, 2 inches×2 inches by four inches, ×2 inches×2 inches by 6 inches, 1 inch×1 inch by 6 inches, etc., as well as objects machined from cut lumber (e.g. molding, spindles, balusters, etc.). Some examples include lumber, boards, veneers, planks, squared timber, beams or profiles. In some embodiments, the solid wood is lumber. Solid wood of any dimension may be used. In some embodiments, the solid wood measures at least about ten centimeters in at least one dimension and at least about 5 millimeters in another dimension. The longest dimension can measure, for example, about three feet, about four feet, about six feet, about eight feet, about ten feet, about twelve feet, about 14 feet, about 16 feet, etc. The longest dimension can also be described as being at least or greater than or equal to any of the foregoing values (e.g. at least about three feet, at least about four feet, greater than or equal to about 12 feet, etc). A second dimension of the wood may be the second longest dimension or may be equal the longest dimension. Some examples of the second longest dimension include about 1/10 inch, about ⅛ inch, about ⅙ inch, about ¼ inch, about ⅓ inch, about ⅜ inch, about 0.5 inch, about ⅝ inch, about 0.75 inches, about one inch, about 1.5 inches, about two inches, about three inches, about four inches, about five inches, about six inches, about eight inches, about nine inches, about ten inches, about 12 inches, about 14 inches, about 16 inches, about 18 inches, about 20 inches, about 24 inches, about three feet, about four feet, etc. The second longest dimension can also be described as being at least or greater than or equal to any of the foregoing values (e.g. at least about 1/10 inch, greater than or equal to about 0.5 inch, at least about 0.75 inch, etc). The third dimension can be the same as or different from the second dimension and can be, for example any of the values described above for the second dimension. In some embodiments, the wood measures the same length in all three dimensions. In some embodiments, the solid wood measures at least about 30 inches in its longest dimension and at least about 0.25 inch in two other dimensions. In some embodiments, the solid wood measures at least about 30 inches in its longest dimension and at least about 0.5 inch in two other dimensions. In some embodiments, the solid wood measures at least about 30 inches in its longest dimension and at least about 0.75 inch in two other dimensions. In some embodiments, the solid wood measures at least about 36 inches in its longest dimension and at least about 0.5 inch in two other dimensions. In some embodiments, the solid wood measures at least about 48 inches in its longest dimension and at least about 0.75 inch in two other dimensions. In some embodiments, the solid wood measures at least about 30 inches in at least one dimension, at least about 1.5 inches in another dimension and at least about 0.5 inch in a third dimension. In some embodiments, the solid wood measures at least about four feet in at least one dimension, at least about 1.5 inches in another dimension and at least about 0.5 inch in a third dimension. In some embodiments, the solid wood measures at least about eight feet in its longest dimension, at least about five inches in another dimension and at least about one inch in a third dimension. By referring to wood that “measures” specific dimensions, it is meant that the stated dimensions are actual measured dimensions and not nominal dimensions. However, these numbers are not limiting and embodiments exist wherein each of the foregoing figures represent nominal dimensions rather than measured dimensions. When two or three dimensions are identified, it is meant that each dimension is at about a 90 degree angle to other stated dimensions (for example, about 0.5 inch thickness by 1.5 inches width by about 30 inches length).

In some embodiments, one of the dimensions described in the foregoing paragraph is parallel to the direction of the grain of the solid wood. Thus, any of the measurements above may describe the dimension of the board in the axis of the grain of the solid wood. In some embodiments, the longest dimension is parallel to the direction of the grain of the solid wood.

The invention allows acetylation of multiple pieces of solid wood, including solid wood of any of the foregoing dimensions, to be esterified at once. In some embodiments, solid wood is arrayed in vertical stacks of two or more pieces with spacers (“stickers”) disposed between the stacked pieces. Stickers are typically small rods of material having a selected thickness, and may be of any effective thickness. Any known or effective thickness or material of composition for stickers may be used. Some example thicknesses of stickers include about ¼ inch, about ⅓ inch, about ⅜ inch, about 0.5 inch, about ⅝ inch, about 0.75 inches, about one inch, about 1.5 inches, about two inches. In some embodiments, efficiency of the acetylation process allows use of fewer stickers in a given stack. For example, in some embodiments, the stickers are arrayed such that a stack of wood is between each sticker, each stack has a thickness of about 0.5 inches and each stack contains multiple pieces of solid wood having dimensions less than about 0.5 inches are stacked between them (for example, four pieces of ⅛ inch thick veneer. Embodiments exist in which the thickness of the stacks of wood between stickers is about 0.75 inches, about one inch, about 1.5 inches, about two inches, about three inches, about four inches, about five inches, about six inches, about eight inches, about nine inches, about ten inches, about 12 inches, about 14 inches, about 16 inches, about 8 inches, about 20 inches, about 24 inches, about three feet about four feet, etc. The thicknesses of the wood in the foregoing sentence can reflect single pieces of wood of such thickness or stacks of wood of such thickness, e.g. for example, a single piece of wood about four inches thick or a stack of four pieces of wood that are each about one inch thick. The thicknesses of the stacks of wood can also be described as being at least or greater than or equal to any of the foregoing values (e.g. at least about 0.75 inch greater than or equal to about 1.5 inches, etc).

Lignocellulosic material may be of any compatible density prior to acetylation. In some embodiments, the wood has a density of between about 0.30 and about 0.65 grams per cubic centimeter, based on the dry weight of the material. In some embodiments, the wood has a density of between about 0.30 and about 0.55 grams per cubic centimeter, based on the dry weight of the material. In some embodiments, the wood has a density of between about 0.40 and about 0.65 grams per cubic centimeter, based on the dry weight of the material. In some embodiments, the wood has a density of between about 0.40 and about 0.60 grams per cubic centimeter, based on the dry weight of the material. In some embodiments, the wood has a density of between about 0.40 and about 0.625 grams per cubic centimeter, based on the dry weight of the material. In some embodiments, the wood has a density of between about 0.40 and about 0.50 grams per cubic centimeter, based on the dry weight of the material. In some embodiments, the wood has a density of between about 0.45 and about 0.55 grams per cubic centimeter, based on the dry weight of the material.

The lignocellulosic material can contain water prior to acetylation. For example, the lignocellulosic material can initially contain at least about 15 weight percent water, at least about 17 weight percent water, or at least about 19 weight percent water prior to esterification. In some embodiments, the lignocellulosic material can be dried or otherwise processed to remove water, to result in a dewatered lignocellulosic material. For example, the dried lignocellulosic material can have a water content of less than about 15 weight percent water, less than about 10 weight percent water, less than about 7.5 weight percent water, or less than about 5 weight percent water. Any effective method can be employed to achieve the desired water content of the lignocellulosic material prior to esterification. Some examples include kiln drying and/or solvent drying by impregnation with a liquid other than water. Any effective solvent may be used in solvent drying, including, for example, acetic acid, methanol, acetone, methyl isobutyl ketone, xylene and ester solvents (e.g. acetate esters such as isopropyl acetate, n-propyl acetate etc.). These processes may be assisted by applying vacuum, pressurized environments, or both, including cycles of multiple stages of vacuum, pressure, or both. Any effective solvent may be used in solvent drying, including, for example, acetic acid, methanol, acetone, methyl isobutyl ketone, xylene and ester solvents (e.g. acetate esters such as isopropyl acetate, n-propyl acetate etc.).

### Acetylation Process

The acetylation of lignocellulosic material (using wood as an example) is shown schematically in equations (1) and (2) below:

Acetic acid acetylation: AcOH+2Wood-OH→Wood-OAc+H₂O (1)

Acetic Anhydride Acetylation: Ac₂O+Wood-OH→Wood-OAc+AcOH (2)

where “Ac” is CH₃CH₂C(O)—.

Accordingly, an AcOH—Ac₂O sequential process for acetylation can be represented by the following scheme:

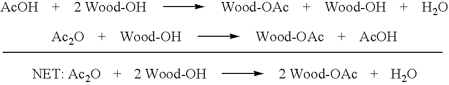

Steps (c) and (d), if performed, acetylate the lignocellulosic material to further degree.

Impregnation Steps (a) and Optionally (c)

Step (a), and if performed, step (c), involve impregnating the lignocellulosic material with acetic acid and acetic anhydride, respectively. Several methods for impregnating lignocellulosic material are known, and any effective method for impregnating the lignocellulosic material may be used. In some embodiments, impregnation occurs by contacting the lignocellulosic material with a liquid containing acetic anhydride, for example by immersing the lignocellulosic material in the liquid. In some embodiments, the pressure under which the impregnation occurs is controlled. For example, in some embodiments the lignocellulosic material is contacted with the liquid in a pressurized vessel or a vessel in which the pressure has been reduced below atmospheric pressure. Changes in pressure may occur before, during or after contact with the liquid. In some embodiments, pressure is varied during or in connection with impregnation. For example, in some embodiments the lignocellulosic material can be placed in a vessel in which vacuum is then created and maintained for a period of time to remove a desired degree of air or other gases in the lignocellulosic material, then contacted with the liquid while maintaining vacuum, and then subjected to pressurization to facilitate impregnation. Multiple steps or cycles of pressurization, vacuum and/or restoration of atmospheric pressure as well as combinations of any or all of these conditions in any order or number of repetition may be used. Pressurization or repressurization may be accomplished by any means, including, but not limited to, adding atmospheric air, adding additional vapors or gases such as inert gases (e.g. nitrogen), adding the impregnating material in liquid or gaseous form, or adding other materials.

The impregnating liquid in (a) may contain any effective amount of acetic acid. In some embodiments, the liquid contains at least about 50% acetic acid by weight. In some embodiments, the liquid contains acetic acid in a concentration of at least about 60% by weight. In some embodiments, the liquid contains acetic acid in a concentration of at least about 70% by weight. In some embodiments, the liquid containing acetic acid contains acetic acid in a concentration selected from at least about 80% by weight, at least about 85% by weight, at least 90% by weight, at least 95% by weight, at least 98% by weight, or even 100% by weight. In some embodiments where the acetic acid is present in an amount less than 100%, the remainder can include, e.g., one or more compatible diluents. Example diluents include water, acetic anhydride, xylene, methanol, acetone, methyl isobutyl ketone, ester solvents (e.g. acetate esters such as isopropyl acetate, n-propyl acetate etc.) and compatible combinations of two or more of the foregoing. In some embodiments, the impregnating liquid may contain acetic anhydride and/or acetic acid that has been previously used in or generated as a byproduct of an acetylation process. Such material may or may not contain wood byproduct materials and derivatives thereof. Some examples include tannins and other polyphenolics, coloring matter, essential oils, fats, resins, waxes, gum starch, or metabolic intermediates.

For the impregnation in step (c), the impregnating liquid may contain any effective amount of acetic anhydride. In some embodiments, the liquid contains at least about 50% acetic anhydride by weight. In some embodiments, the liquid contains at least about 60% acetic anhydride by weight. In some embodiments, the liquid contains at least about 75% acetic anhydride by weight. In some embodiments, the liquid contains at least about 80% acetic anhydride by weight. In some embodiments, the liquid contains at least about 85% acetic anhydride by weight. In some embodiments, the liquid contains at least about 90% acetic anhydride by weight. In some embodiments, the liquid contains at least about 95% acetic anhydride by weight. In some embodiments, the liquid contains at least about 98% acetic anhydride by weight. In some embodiments, the impregnating liquid that contains acetic anhydride also contains acetic acid. In some embodiments, the impregnating liquid may contain acetic anhydride and/or acetic acid that has been previously used in or generated as a byproduct of an acetylation process. Such material may or may not contain wood byproduct materials and derivatives thereof. Some examples include tannins and other polyphenolics, coloring matter, essential oils, fats, resins, waxes, gum starch, or metabolic intermediates. In some embodiments of (c), the liquid containing acetic anhydride has an acetic anhydride:acetic acid ratio ranging from 60:40 to 100:0. In some embodiments of (c), the liquid containing acetic anhydride has an acetic anhydride:acetic acid ratio ranging from 75:25 to 100:0. In some embodiments of (c), the liquid containing acetic anhydride has an acetic anhydride:acetic acid ratio ranging from 90:10 to 100:0. In some embodiments wherein the acetic anhydride:acetic acid ratio ranges from 60:40 to 100:0, a liquid containing essentially no acetic acid can still contain as little as 60% acetic anhydride since this mixture results in an acetic anhydride:acetic acid ratio of 100:0. The liquid can contain acetic anhydride and a diluent. Example diluents include example, acetic acid, methanol, acetone, methyl isobutyl ketone, xylene and ester solvents (e.g. acetate esters such as isopropyl acetate, n-propyl acetate etc.).

Contacting Steps (b) and Optionally (d)

The “contacting” in (b) and optionally, (d) involves contacting the lignocellulosic material with a vapor stream. Vapor results in heating of the lignocellulosic material. The heating accelerates the acetylation reaction. In some embodiments, the heat may first cause commencement or acceleration of reaction of acetic anhydride with water present in the lignocellulosic material. That reaction is exothermic and will result in further heating of the lignocellulosic material.

The vapor in (b) (and optionally, (d) may be generated by any effective means. In some embodiments, the vapor is generated by contact or non-contact heating. Examples of non-contact heating involve use of steam or any other effective heat transfer method. In some embodiments, the heating involves a heat exchanger containing steam at a selected pressure. Examples include about 15 pounds/square inch, gauge pressure (psig), about 20 psig, about 25 psig, about 30 psig, about 40 psig, about 50 psig, about 60 psig, about 70 psig, about 80 psig, about 90 psig, about 100 psig, about 125 psig, about 150 psig, about 200 psig, about 250 psig and about 300 psig. The steam, pressure can also be described as being at least or greater than or equal to any of the foregoing values.

The vapor stream containing acetic acid in (b) is obtained by boiling a composition that contains at least about 50% acetic acid by weight. In some embodiments, the vapor is the result of boiling a composition that contains at least about 75% acetic acid by weight. In some embodiments, the vapor stream is the result of boiling a composition that contains acetic acid in a concentration of at least about 80% by weight. In some embodiments, the vapor is the result of boiling a composition that contains at least about 85% acetic acid by weight. In some embodiments, the vapor is the result of boiling a composition that contains at least about 90% acetic acid by weight. In some embodiments, the vapor is the result of boiling a composition that contains at least about 95% acetic acid by weight. In some embodiments, the vapor contains between about 50% and about 100% acetic acid by weight. In some embodiments, the vapor contains between about 75% and about 100% acetic acid by weight. In some embodiments, the vapor contains between about 85% and about 100% acetic acid by weight. In some embodiments, the vapor contains between about 90% and about 100% acetic acid by weight. In some embodiments, the vapor contains at least about 98% acetic acid by weight. In some embodiments, the vapor has the same percent acid content by weight as the liquid that was boiled to produce the vapor. In some embodiments, the vapor contains between about 50% and about 100% acetic acid by weight. In some embodiments, the vapor contains between about 75% and about 100% acetic acid by weight. In some embodiments, the vapor contains between about 85% and about 100% acetic acid by weight. In some embodiments, the vapor contains between about 90% and about 100% acetic acid by weight. In some embodiments, the vapor contains at least about 98% acetic acid by weight. The remainder of composition may be any compound or combination of compounds that does not unduly interfere with the esterification. In some embodiments, the boiled composition also contains one or more diluents in addition to the acetic acid. In some embodiments, the composition contains acetic anhydride, for example where the vapor is the result of boiling a composition that contains about 95% acetic acid and about 5% acetic anhydride by weight. Thus, in some embodiments the vapor stream is the result of boiling a composition that contains both acetic anhydride and acetic acid. In some embodiments, the vapor stream is the result of boiling a composition that contains acetic acid in one of the percentages above, and acetic anhydride (e.g., about 80:20 acid/anhydride, about 85:15 acid/anhydride, about 90:10 acid/anhydride, or about 95:5 acid/anhydride). Thus, in some embodiments, the vapor in (b) has an acid/anhydride ratio in the range from about 50:50 to about 99:1. In some embodiments, the vapor in (b) has an acid/anhydride ratio in the range from about 75:25 to about 99:1. In some embodiments, the vapor in (b) has an acid/anhydride ratio in the range from about 75:25 to about 95:1. The boiling can occur at a temperature effective to allow the vapor to boil and enter the pressurized reactor. The vapor stream can further contain a diluent in addition to the acetic acid, such as any diluent described herein (for example, the diluents described for (a)).

In some embodiments, the vapor stream in (b) further contains at least one agent that will form an azeotrope with water. Example azeotropic agents include xylene, toluene, methyl isobutyl ketone, acetate esters and combinations of two or more of the foregoing.

The vapor stream in (d), where used, contains acetic acid, acetic anhydride, or both. In some embodiments, the vapor stream in (d) is the result of boiling a composition that contains at least about 50% acetic anhydride by weight. In some embodiments, the vapor is the result of boiling a composition that contains at least about 60% acetic anhydride by weight. In some embodiments, the vapor is the result of boiling a composition that contains at least about 75% acetic anhydride by weight. In some embodiments, the vapor stream is the result of boiling a composition that contains acetic anhydride in a concentration of at least about 80% by weight. In some embodiments, the vapor is the result of boiling a composition that contains at least about 85% acetic anhydride by weight. In some embodiments, the vapor is the result of boiling a composition that contains at least about 90% acetic anhydride by weight. In some embodiments, the vapor is the result of boiling a composition that contains at least about 95% acetic anhydride by weight. In some embodiments, the vapor is the result of boiling a composition that contains at least about 98% acetic anhydride by weight. In some embodiments, the vapor has the same percent anhydride content by weight as the liquid that was boiled to produce the vapor. In some embodiments, the vapor contains between about 50% and about 100% acetic anhydride by weight. In some embodiments, the vapor contains between about 75% and about 100% acetic anhydride by weight. In some embodiments, the vapor contains between about 85% and about 100% acetic anhydride by weight. In some embodiments, the vapor contains between about 90% and about 100% acetic anhydride by weight. In some embodiments, the vapor contains at least about 98% acetic anhydride by weight. The remainder of composition may be any compound or combination of compounds that does not unduly interfere with the esterification. In some embodiments, the boiled composition also contains one or more diluents in addition to the acetic anhydride. Example diluents include acetic acid, xylene, methanol, acetone, methyl isobutyl ketone, ester solvents (e.g. acetate esters such as isopropyl acetate, n-propyl acetate etc.) and combinations of two or more of the foregoing.

In some embodiments, the vapor in (d) is the result of boiling a composition that contains at least about 50% acetic acid by weight. In some embodiments, the vapor is the result of boiling a composition that contains at least about 60% acetic acid by weight. In some embodiments, the vapor is the result of boiling a composition that contains at least about 75% acetic acid by weight. In some embodiments, the vapor stream is the result of boiling a composition that contains acetic acid in a concentration of at least about 80% by weight. In some embodiments, the vapor is the result of boiling a composition that contains at least about 85% acetic acid by weight. In some embodiments, the vapor is the result of boiling a composition that contains at least about 90% acetic acid by weight. In some embodiments, the vapor is the result of boiling a composition that contains at least about 95% acetic acid by weight. In some embodiments, the vapor has the same percent acid content by weight as the liquid that was boiled to produce the vapor. In some embodiments, the vapor contains between about 50% and about 100% acetic acid by weight. In some embodiments, the vapor contains between about 75% and about 100% acetic acid by weight. In some embodiments, the vapor contains between about 85% and about 100% acetic acid by weight. In some embodiments, the vapor contains between about 90% and about 100% acetic acid by weight. In some embodiments, the vapor contains at least about 98% acetic acid by weight. The remainder of composition may be any compound or combination of compounds that does not unduly interfere with the esterification. In some embodiments, the boiled composition also contains one or more diluents in addition to the acetic acid. In some embodiments, the composition contains acetic anhydride, for example where the vapor is the result of boiling a composition that contains about 95% acetic acid and about 5% acetic anhydride by weight. Thus, in some embodiments the vapor stream is the result of boiling a composition that contains both acetic anhydride and acetic acid. In some embodiments, the vapor stream is the result of boiling a composition that contains acetic acid in one of the percentages above, and acetic anhydride (e.g., about 80:20 acid/anhydride, about 85:15 acid/anhydride, about 90:10 acid/anhydride, or about 95:5 acid/anhydride). The boiling can occur at a temperature effective to allow the vapor to boil and enter the pressurized reactor. In some embodiments, the boiled composition also contains one or more diluents in addition to the acetic acid. Example diluents include acetic acid, xylene, methanol, acetone, methyl isobutyl ketone, ester solvents (e.g. acetate esters such as isopropyl acetate, n-propyl acetate etc.) and combinations of two or more of the foregoing. In some embodiments, the vapor has the same composition by weight as the liquid that was boiled to produce the vapor.

Thus, in some embodiments, the vapor in (d) has an anhydride/acid ratio in the range from about 50:50 to about 99:1. In some embodiments, the vapor in (d) has an anhydride/acid ratio in the range from about 75:25 to about 99:1. In some embodiments, the vapor in (d) has an anhydride/acid ratio in the range from about 75:25 to about 95:1. In some embodiments, the vapor has about the same composition by weight as the liquid that was boiled to produce the vapor.

In some embodiments, the acetylation process described herein reduces the water content of the lignocellulosic material. In some embodiments, the lignocellulosic material prior to the impregnating in (a) has a water content ranging from 1% to 20% by weight. In some embodiments, the lignocellulosic material prior to the impregnating in (a) has a higher water content (e.g. undried lignocellulosic material), and the contacting in (b) is performed until the lignocellulosic material has a water content of less than or equal to 8% by weight, such as a water content of less than or equal to 2% by weight. In some embodiments, the contacting in (b) is performed until the lignocellulosic material has a water content ranging from 5% to 6% by weight. In some embodiments, the contacting in (b) is performed until the lignocellulosic material has a water content of less than about 1% by weight.

The contacting in (b) and/or (d) can be performed in the presence or absence of at least one component chosen from acetylation catalysts, colorants, and biocides. In some embodiments, the process occurs with an acetylation catalyst present in step (b), step (d) or both. In some embodiments, the process occurs without an effective amount of added acetylation catalyst. “Acetylation catalyst” refers to any compound that, combined with the lignocellulosic material before or during acetylation that measurably increases the rate of the acetylation reaction, reduces the amount of energy required to initiate the acetylation reaction, or both. In some embodiments, the catalyst operates through acid or base catalysis. Some examples of acetylation catalysts include pyridine, dimethylaminopyridine, trifluoroacetic acid, metal acetate salts (e.g. potassium acetate, sodium acetate, etc.), perchloric acid and perchlorate metal salts. “Effective amount” in connection with catalyst simply refers to the amount that, when present, results in such noticeable effects. In some embodiments where catalysts are used, the catalysts are introduced at an earlier point in the process, for example a catalyst introduced in (a) for use in (b).

In some embodiments, the administration of vapor is accompanied by other means of applying heat. Any effective means of supplementing heat may be used. Some examples include application of electromagnetic radiation (e.g. microwave, infrared, or radiofrequency heating) or application of heat to the outer wall of the reactor (e.g. using a jacket of heat transfer medium). The exothermic reaction of acetic anhydride with water in the lignocellulosic material is also a source of heat. The exothermic acetylation reaction also provides a source of heat that may accelerate the commencement of the reaction in other lignocellulosic material.

The contacting in (b) or (d) can be performed at any effective temperatures. For instance, the contacting in (b) and/or (d) can be performed with the vapor at a temperature ranging from 50° C. to 230° C. In some embodiments, the contacting in (b) and/or (d) is performed with the vapor at a temperature ranging from 70° C. to 200° C. In some embodiments, the contacting in (b) and/or (d) is performed at a temperature ranging from 90° C. to 170° C.

Duration of the application of heated vapor is another process variable that can be manipulated. In some embodiments, application of heated vapor is discontinued when a specific point is reached, such as passage of a desired length of time after commencement of heat application. Some examples include about 20 minutes, about 25 minutes, about 30 minutes, about 40 minutes, about 45 minutes, about 50 minutes about 55 minutes, about 60 minutes, about 75 minutes, about 90 minutes, about 2 hours, about 3 hours, about 4 hours, about 5 hours, and about 6 hours. In some embodiments, application of heated vapor is discontinued when a desired temperature at one or more locations in the batch of lignocellulosic materials is measured. Some example temperatures include about 50° C., about 60° C., about 70° C., about 80° C., about 90° C., about 100° C., about 110° C., about 120° C., about 130° C., about 140° C., about 150° C., about 160° C., about 170° C., about 180° C. and about 190° C. Discontinuation can also be determined based on attainment of a selected internal pressure or in the drop of a temperature or pressure below a selected value toward the end of the reaction. Discontinuation can also be determined based on passage of a specified amount of time after attainment of a selected temperature. In some embodiments, applications of other sources of heat may also be discontinued at the same determined point or at a different point in the process. The foregoing examples are not limiting, and any acceptable endpoint can be used.

The contacting in (b) or (d) can be performed under any effective pressure. In some embodiments, the pressure is maintained in the range of from about 20 to about 7700 Torr during the application of the heated vapor stream. In some embodiments, the pressure is maintained in the range of from about pressure to about 5000 Torr during the application of the heated vapor stream. In some embodiments, the pressure is maintained in the range of from about 1000 Torr to about 3500 Torr during the application of the heated vapor stream. In some embodiments, the pressure is maintained in the range of from about 1200 Torr to about 2600 Torr during the application of the heated vapor stream. In some embodiments, the pressure is maintained in the range of from about 750 to about 5000 torr during the application of the heated vapor stream during the application of the heated vapor stream. In some embodiments, the pressure is maintained in the range of from about 750 to about 2250 torr during the application of the heated vapor stream during the application of the heated vapor stream. In some embodiments, the pressure is maintained in the range of from about 1000 to about 2000 torr during the application of the heated vapor stream. In some embodiments, the pressure is maintained in the range of from about 1300 to about 1700 torr during the application of the heated vapor stream. In some embodiments, the pressure is maintained in the range of from about 500 to about 1500 torr during the application of the heated vapor stream. In some embodiments, the pressure is maintained in the range of from about 1500 to about 2500 torr during the application of the heated vapor stream. In some embodiments, the pressure is maintained in the range of from about 750 to about 1250 torr during the application of the heated vapor stream. In some embodiments, the pressure is maintained in the range of from about 900 to about 1110 torr during the application of the heated vapor stream. In some embodiments, the pressure is maintained in the range of from about 1750 to about 2250 torr during the application of the heated vapor stream. The contacting in (b) and/or (d) may be performed at the same pressure or at different pressures.

### Resulting Acetylated Lignocellulosic Material

The extent of acetylation can be measured by determining the weight percent gain (WPG), i.e., the amount of weight gained by the lignocellulosic material upon acetylation relative to the original weight of the lignocellulosic material before acetylation (WPG(%)=[{(weight after acetylation)minus(original dry weight)}/(original dry weight)]×100). In some embodiments, after steps (a) and (b), the lignocellulosic material has a WPG ranging from 4 to 15. In some embodiments, the WPG after step (d) is an amount ranging from 8 WPG to 35 WPG. In some embodiments, the WPG in (b) is at least 25% the WPG in (d). In some embodiments, the WPG in (b) is at least 50% the WPG in (d).

Another measurement for extent of acetylation is percent bound acetyl. As used herein, “percent bound acetyl” or “percent bound acetyl groups” is determined according to the following procedure or an equivalent method. The % free acetic acid in the lignocellulosic material as well as the total acetyl groups. % free acetic acid is subtracted from the % total acetyl groups acetyl groups (measured as acetic acid) to give % bound acetyl groups, and then multiplied by a ratio representing the mole weight of the acetyl group divided by the mole weight of acetic acid (that is, 43/60). This can be shown by equation (3) below:

% Bound Acetyl=(% Total acetic acid−% Free acetic acid)*(43/60) (3)

Measurements are made using a sample of the lignocellulosic material having the thickness of drill bit shavings or smaller and weighing approximately 0.5 g. To determine % Total acetic acid, the sample is placed in a pre-tared 8-dram vial. The sample weights are recorded (to the nearest 0.1 mg). 20 mL of 10 mM sodium bicarbonate (Mallinckrodt #7412-12, or equivalent) are pipetted into the vial, and the vial is sealed and set at ambient temperature for two hours. 2 mL of the liquid supernatant is pipetted into a 10 mL flask, 0.1 mL of 85% phosphoric acid (Mallinckrodt #2796, or equivalent) is added, and the liquid is diluted to 10 mL with HPLC grade water (ASTM Type 1 HPLC grade). The resulting solution is mixed thoroughly and filtered using a 0.45 micron nylon filter. The % acetic acid content of the filtered solution is then determined by reversed phase liquid chromatography using a HYDROBOND PS-C18 column (MAC MOD Analytical Inc., Chadd's Ford, PA), or equivalent, the column being thermostatted to hold temperature at 25 degrees C., with detection using an Agilent 1100 Diode Array Series Variable Wavelength Detector (Agilent Technologies, Inc., Santa Clara, Calif.) or equivalent at 210 nm. The acetic acid is separated isocratically using 50 millimolar phosphoric acid for seven minutes, followed by an acetonitrile column flush and five minute reequilibration. The acetic acid (retention time approximately four minutes) is photometrically detected at 210 nm to provide the % free acetic acid. A calibration curve is prepared over the range of 10-1000 ppm (corresponding to masses of 0.001-0.1 g of acetic acid in 100 mL calibration solutions). For the sample, the resultant area under the acetic acid peak is compared against the calibration curve to provide an acetic acid quantity in grams per 100 mL of sample solution. To determine the total acetyl groups (measured as acetic acid) 2 mL of 40% (w/v) sodium hydroxide (Mallinckrodt #7708-10, or equivalent) are pipetted into the remaining 18 mL % free acetic acid solution prepared above. The vial is sealed and mechanically shaken for at least two hours with a shaker adjusted to the minimum speed necessary to keep the lignocellulosic materials suspended. 1 mL of the liquid supernatant is pipetted into a 100 mL flask, 1 mL of 85% phosphoric acid (Mallinckrodt #2796, or equivalent) is added, and the liquid is diluted to 100 mL with HPLC grade water (ASTM Type 1 HPLC grade). The resulting solution is mixed thoroughly and filtered using a 0.45 micron nylon filter. The % acetic acid content of the filtered solution is then determined using the same chromatography procedures. This value and the % free acetic acid value are entered into formula 3 to provide % bound acetyl.

The invention also provides acetylated lignocellulosic materials made by the methods of the present invention. In some embodiments, application of one or more of the foregoing methods results in acetylated lignocellulosic material in which the degree of acetylation (as measured by percent bound acetyl groups) is at least about 10 weight percent. In some embodiments, the percent bound acetyl groups of the acetylated lignocellulosic material is at least about 15 weight percent. In some embodiments, the percent bound acetyl groups of the acetylated lignocellulosic material is at least about 16 weight percent. In some embodiments, the percent bound acetyl groups of the acetylated lignocellulosic material is at least about 17 weight percent. In some embodiments, the percent bound acetyl groups of the acetylated lignocellulosic material is at least about 18 weight percent. In some embodiments, the percent bound acetyl groups of the acetylated lignocellulosic material is at least about 19 weight percent. In some embodiments, the percent bound acetyl groups of the acetylated lignocellulosic material is at least about 20 weight percent. In some embodiments, the resulting percent bound acetyl can be from about 2 weight percent to about 30 weight percent, from about 10 weight percent to about 25 weight percent, or from about 15 weight percent to about 25 weight percent. For each of the above percentages, embodiments exist wherein the above percentages are found in an entire batch of lignocellulosic materials produced by an acetylation process. Embodiments also exist for each of the above percentages wherein the stated percent bound acetyl values are found in all non-heartwood in an entire batch of lignocellulosic material produced by an acetylation process. Embodiments also exist for each of the above percentages wherein the stated percent bound acetyl values are found in an entire piece of acetylated solid wood. Embodiments also exist for each of the above percentages wherein the stated percent bound acetyl values are found in all non-heartwood portions of an entire piece of acetylated solid wood. Embodiments also exist for each of the above percentages wherein the stated percent bound acetyl values are found in an entire group of stacks of acetylated solid wood (separated by stickers) from a given acetylation batch. Embodiments also exist for each of the above percentages wherein the stated percent bound acetyl values are found in all non-heartwood portions of an entire group of stacks of acetylated solid wood (separated by stickers) from a given acetylation batch. As used throughout this application, “non-heartwood” acetylated lignocellulosic material refers to material for which the source lignocellulosic material is not taken from the heartwood of a tree.

In some embodiments, the resulting acetylated lignocellulosic material in which the variation (i.e. the difference between the highest and lowest percentages of bound acetyl groups by weight found in a given batch) in the percent bound acetyl groups of acetylated non-heartwood lignocellulosic material is no more than about 5 percentage points. In some embodiments, the variation in the percent bound acetyl groups of acetylated non-heartwood lignocellulosic material is no more than about 3 percentage points. In some embodiments, the variation in the percent bound acetyl groups of acetylated non-heartwood lignocellulosic material is no more than about 2 percentage points. In some embodiments, variation in the percent bound acetyl groups of acetylated non-heartwood lignocellulosic material is no more than about 1 percentage point.

In some embodiments, the resulting acetylated lignocellulosic material in which the variation in the percent bound acetyl groups of non-heartwood lignocellulosic material having a density between about 0.45 and about 0.60 grams is no more than 5 about percentage points. In some embodiments, the variation in the percent bound acetyl groups of non-heartwood lignocellulosic material having a density between about 0.45 and about 0.60 grams is no more than about 3 percentage points. In some embodiments, the variation in the percent bound acetyl groups of non-heartwood lignocellulosic material having a density between about 0.45 and about 0.60 grams is no more than about 2 percentage points. In some embodiments, variation in the percent bound acetyl groups of non-heartwood lignocellulosic material having a density between about 0.45 and about 0.60 grams is no more than about 1 percentage point. “Non-heartwood lignocellulosic material having a density between about 0.45 and about 0.60 grams” refers to acetylated lignocellulosic material for which the source lignocellulosic material was not taken from the heartwood of a tree and had a density between about 0.45 and about 0.60 grams. Density values used in this application are based on dry weight.

In some embodiments, the resulting acetylated lignocellulosic material in which the variation in the percent bound acetyl groups of a given batch is no more than about 5 percentage points for the entire portion of such acetylated lignocellulosic material that has a density between about 0.45 and about 0.60. In some embodiments, the variation in the percent bound acetyl groups of a given batch is no more than about 3 percentage points for the entire portion of such acetylated lignocellulosic material that has a density between about 0.45 and about 0.60. In some embodiments, the variation in the percent bound acetyl groups of a given batch is no more than about 2 percentage points for the entire portion of such acetylated lignocellulosic material that has a density between about 0.45 and about 0.60. In some embodiments, variation in the percent bound acetyl groups of a given batch is no more than about 1 percentage points for the entire portion of such acetylated lignocellulosic material that has a density between about 0.45 and about 0.60.

### Further Processing of Acetylated Lignocellulosic Materials

In some embodiments, the acetylated lignocellulosic material may be subjected to further processing. For example, in some embodiments the lignocellulosic material is processed to remove excess esterifying compound and/or reaction byproducts present in the lignocellulosic material. Thus, the acetylation methods of the invention may also include:

(e) removing at least some of the excess acetic anhydride and/or acetic acid from the contacted lignocellulosic material in step (d). This can be performed in the same reaction vessel as the acetylation processes or in a different location. This removal process can be any process capable of lowering the content of acetic acid and/or acetic anhydride to any desired level. Examples of processes that can be employed in the present invention include, but are not limited to, application of electromagnetic radiation (e.g. microwave radiation, radiofrequency radiation, radiant infrared radiation etc.), with or without inert gas (e.g., nitrogen) flow, storing below atmospheric pressure, addition of heated vapor (e.g. steam) to the reaction vessel, addition of water to the reaction vessel, drying in a kiln, or combinations of two or more of the foregoing.

Acetylated lignocellulosic materials can also be subjected to any additional further treatments that may be desirable. Some examples include treatment with biocides, applications of stains or coatings, cutting into desired dimensions and shapes, chipping or refining into smaller materials, and the like.

In some embodiments, the lignocellulosic material after step (e) contains acetic acid in an amount less than 5% by weight. In some embodiments, the lignocellulosic material after step (e) contains acetic acid in an amount less than 3% by weight. In some embodiments, the lignocellulosic material after step (e) contains acetic acid in an amount less than 2% by weight. In some embodiments, the lignocellulosic material after step (e) contains acetic acid in an amount less than 1% by weight.

### Articles

The invention further provides articles containing or made of the lignocellulosic materials of the present invention. Some examples include, lumber, engineered wood, architectural materials (e.g. decking, joists, struts, banisters, indoor flooring, balusters, spindles, doors, trim, siding, molding, windows and window components, studs, etc.), playground equipment, fencing, furniture, utility poles, pilings, docks, boats, pallets and containers, railroad ties.

This invention can be further illustrated by the following examples of preferred embodiments thereof, although it will be understood that these examples are included merely for purposes of illustration and are not intended to limit the scope of the invention unless otherwise specifically indicated.

### Examples

### Reactor Designs

The reactors used for these examples include a horizontal two foot glass reactor, a horizontal four foot glass reactor, a ten foot stainless steel reactor, and a two foot vertical glass unit. Reactors were constructed by Eastman Chemical Company and Lab Glass Inc.

A horizontal glass reactor two feet long and eight inches in diameter with an eight inch Shott flange at one end was prepared. The opposite end was closed and fitted with ball joints for connection to a three liter reboiler flask and a heated nitrogen flow meter. The working volume of the unit was about 5 gallons the unit could hold three 18 inch deck boards or their equivalent. The unit had thermocouples attached to the outside glass surface. The unit was sandwiched with insulation tape and heat tape and covered with blanket insulation. The unit was also equipped with an internal temperature thermocouple. The unit had a take off head for condensation and removal of distillate.

### Example 1

### Acetylation of Southern Yellow Pine

Three deck boards (nominal 5.5″×1″×18″) comprised of Southern Yellow Pine and with a moisture content (MC) of 10% were placed in the reactor unit. Vacuum (250 mmHg) was applied and glacial acetic acid was pulled in under vacuum to completely submerge the boards. The pressure was lowered to 2.67 kPa and held at 20° C. for 30 minutes. The vacuum was then released to atmospheric pressure and the boards were allowed to soak for an additional 15 minutes. This vacuum impregnating cycle was repeated twice. The acid was then drained from the unit and the unit was set up to feed acid vapors.

The three liter round bottom flask was charged with acetic acid and brought to reflux (118° C.). The acid vapors passed through the unit, heating the boards, and were condensed. As the distilled acid was taken off, fresh acid was fed to the reboiler to maintain a constant level. The distillate was periodically analyzed for water content. A comparison was made between the original water content of the boards and the amount of water collected in the distillate. When the calculated amount of water was approximately constant, the boards were considered free of water and the acids vapors were stopped.

The original water content of the boards was expressed as Moisture Content (MC). Moisture Content is defined as the weight of water in wood expressed as a fraction, usually a percentage, of the weight of ovendry wood. It was measured by using a moisture meter such as a Model MMC 220 by Wagner Electronics Products, Inc, 326 Pine Grove Road, Rogue River, Oreg., 97537, USA. Alternatively, Moisture Content is measured by using ASTM D4442, oven drying and is expressed by formula (4):

Moisture Content(%)=MC=[(Wet Weight of Wood−Ovendry Weight)/Ovendry Weight]×100. (4)

After cooling the unit was charged with acetic anhydride to again submerge the boards. The above vacuum impregnating cycle was repeated three times to impregnate the boards with acetic anhydride. The acetic anhydride was then drained from the unit. Acetic anhydride was charged to the reboiler unit and brought up to reflux temperature (138° C.). The anhydride vapors pass through the unit, heating the boards to the desired reaction temperature, and were condensed. During this time, the boards were acetylated and the acetic acid was liberated and co-distilled with the anhydride. The acid content of the distillate was monitored. Additional anhydride was added to the reboiler as liquid was removed. At a predetermined concentration of acid in the distillate, the desired level of acetylation was achieved, and the reboiler is cooled and isolated from the unit.

Vacuum and heat were applied to the unit to remove residual acetic acid and acetic anhydride. A warm nitrogen stream can also be applied to the unit to aid in liquid removal. When the boards are free of acid and anhydride, they are cooled and removed. A degree of acetylation is between 8-25%, dependent upon how long the boards are subject to acetylation conditions. Results that demonstrate the WPG achieved in the acetylation process are shown in Table 1.

TABLE 1

| Run | 1-1 | 1-2 | 1-3 | 1-4 | 1-5 | 1-6 | 1-7 |
|---|---|---|---|---|---|---|---|
| # Boards | 3 | 3 | 3 | 3 | 3 | 2 | 2 |
| Wt | 2.2 | 2.3 | 3.1 | 3.1 | 2.4 | 1.2 | 1.1 |
| boards, | | | | | | | |
| kg | | | | | | | |
| Starting | 17 | 9.2 | 7.5 | 7.5 | 11.2 | 13.1 | 19.4 |
| MC | | | | | | | |
| Wt Acetic | 2.5 | 2.8 | 1.6 | 6.1 | 6.6 | 0.8 | 1.2 |
| Acid | | | | | | | |
| Distilled, | | | | | | | |
| kg | | | | | | | |
| Water | 6.1 | 3.5 | 6.5 | 2.9 | 1.1 | 9.9 | 5.3 |
| Content | | | | | | | |
| of Final | | | | | | | |
| Acid | | | | | | | |
| Distillate, | | | | | | | |
| % | | | | | | | |
| Time, hrs | 8 | 7 | 6 | 5 | 4 | 2 | 7.2 |
| of Acid | | | | | | | |
| Distillation | | | | | | | |
| Wt Ac₂O | 5.6 | 2.1 | 0.6 | 1.6 | 5.1 | 0.6 | 2.5 |
| Distilled, | | | | | | | |
| kg | | | | | | | |
| Acid | 8.6 | 9.7 | 58 | 5.4 | 7.2 | 18 | 4.7 |
| Content | | | | | | | |
| of Final | | | | | | | |
| Ac₂O | | | | | | | |
| Distillate, | | | | | | | |
| % | | | | | | | |
| WPG | 24.2 | 21.2 | 15.3 | 27.6 | 18.2 | 28.4 | 25.2 |
| % Acetyl | 18.2 | 17.1 | 12.1 | 20.4 | 15.9 | 22.3 | 18.3 |

### Example 2

### Acetylation of Radiata Pine

The reaction conditions described above for the acetylation of Southern Yellow Pine were used with boards are constructed of Radiata Pine. Runs 2-1 through 2-3 in Table 2 illustrate results for this process.

### Example 3

### Acetylation with Acetic Anhydride of Less than 100% Anhydride

The reaction conditions of Example 1 were used except the anhydride assayed 87% anhydride and 13% acetic acid. Runs 3-1 and 3-2 in Table 2 illustrate results for this process.

TABLE 2

| Run | 2-1 | 2-2 | 2-3 | 3-1 | 3-1 |
|---|---|---|---|---|---|
| Anhydride | 100 | 100 | 100 | 87/13 | 87/13 |
| Board | Radiata | Radiata | Radiata | SYP | SYP |
| Type | Pine | Pine | Pine | | |
| # Boards | 2 | 2 | 2 | 2 | 2 |
| Wt | 3.0 | 3.1 | 0.66 | 1.3 | 1.4 |
| boards, | | | | | |
| kg | | | | | |
| Starting | 6 | 4 | 9.1 | 7.5 | 9.2 |
| MC | | | | | |
| Wt Acetic | 6.3 | 4.7 | 0.90 | 3.5 | 4.0 |
| Acid | | | | | |
| Distilled, | | | | | |
| kg | | | | | |
| Water | N/A | N/A | 1.3 | 5.2 | 2.5 |
| Content | | | | | |
| of Final | | | | | |
| Acid | | | | | |
| Distillate, | | | | | |
| % | | | | | |
| Time, hrs | 3.2 | 2.9 | 2 | 3.2 | 4 |
| of Acid | | | | | |
| Distillation | | | | | |
| Wt Ac₂O | 8.0 | 4.2 | 0.40 | 3.3 | 5.8 |
| Distilled, | | | | | |
| kg | | | | | |
| Acid | N/A | N/A | 33 | 10.5 | 18 |
| Content | | | | | |
| of Final | | | | | |
| Ac₂O | | | | | |
| Distillate, | | | | | |
| % | | | | | |
| WPG | 25.3 | 21.5 | 17.2 | 19.2 | 19.8 |
| % Acetyl | 18.5 | 15.7 | 16.25 | 16.9 | 17.2 |

### Example 4

### Acetylation of Larger Boards

The reaction conditions of Example 1 were used on boards having the dimensions (in inches) illustrated in Table 3.

TABLE 3

| Run | Board Size | WPG | % Acetyl |
|---|---|---|---|
| 4-1 | 2 × 6 × 18 | 19.5 | 18.2 |
| 4-2 | 2 × 4 × 18 | 20.0 | 17.5 |
| 4-3 | 1 × 5.5 × 48 | 24.5 | 21.5 |
| 4-4 | 1 × 5.5 × 96 | 22.7 | 18.2 |
| 4-5 | 4 × 4 × 96 | 30.4 | 21.7 |
| 4-6 | 6 × 6 × 96 | 24.9 | 19.9 |

### Example 5

### Acetylation of Boards with Acetic Acid

Three deck boards (nominal 5.5″×1″×18″) comprised of Southern Yellow Pine and with a MC of 10% were placed in a reactor unit. Vacuum (250 mmHg) was applied and glacial acetic acid was pulled in under vacuum to completely submerge the boards. The pressure was lowered to 20 mmHg and held at ambient temperature for 30 minutes. The vacuum is released to atmospheric pressure and the boards are allowed to soak for 15 minutes. This vacuum impregnating cycle was repeated twice. The acid was then drained from the unit, and the unit was set up to feed acid vapors.

The three liter round bottom flask was charged with acetic acid and brought to reflux (118° C.). The acid vapors passed through the unit, heating the boards and were condensed. As the distilled acid was taken off, fresh acid was fed to the reboiler to maintain a constant level. The distillate was periodically analyzed for water content. A comparison was made between the original water content of the boards and the amount of water collected in the distillate. When the calculated amount of water was approximately constant, the boards were considered free of water and the acids vapors were stopped.

To achieve up to 12 WPG using acetic acid, the acid vapors were continued to be generated and fed to the reactor. The vapor, containing acetic acid and the water of reaction, was condensed and removed. In one embodiment, a 10 WPG was realized. Result of this process are illustrated in Table 4.

TABLE 4

| Run | 5-1 | 5-2 | 5-3 | 5-4 |
|---|---|---|---|---|
| # Boards | 3 | 1 | 1 | 1 |
| Wt boards, kg | 16.5 | 0.7 | .9 | .7 |
| Starting MC | 6 | 5.2 | 10.1 | 24.2 |
| Wt Acetic Acid | 5.9 | 2.5 | 2.9 | 1.9 |
| Distilled, kg | | | | |
| Water Content | N/A | 3.1 | 1.3 | 4.4 |
| of Final Acid | | | | |
| Distillate, % | | | | |
| Time, hrs of | 4.0 | 2.0 | 4.2 | 5.2 |
| Acid | | | | |
| Distillation | | | | |
| WPG | 12.4 | 10.2 | 9.5 | 10.2 |
| % Acetyl | 11.1 | 7.4 | 6.8 | 7.6 |

### Example 6

### Water Removal and Acetylation with Acetic Acid Using an Azeotroping Agent

The process conditions of Examples 1 and 2 were used with the addition of about 2-4% of n-propyl acetate to the acetic acid. In addition, the take off head was replaced with a small distillation column and a decanter that allowed for the separation of the water/n-propyl acetate azeotrope and return of the n-propyl acetate to the column. By continuing the vapors from the reboiler and underflowing acetic acid condensate from the reactor back to the reboiler, water could continuously be removed from the decanter. From a mass balance of water removed a WPG of 11 could be realized. Results of this process are illustrated in Table 5.

TABLE 5

| Run Number | 6-1 | 6-2 | 6-3 | 6-4 |
|---|---|---|---|---|
| Number Boards | 2 | 1 | 1 | 1 |
| Wt of Boards, kg | 0.8 | 0.8 | 0.77 | 0.5 |
| WPG | 8.9 | 9.4 | 7.2 | 10.6 |

### Example 7

### Stainless Steel 10 Foot Unit Reactor System Design and Process

In this embodiment, the reactor was a horizontal jacketed metal 10″ pipe, 10 feet long. The jacket was heated with up to 90 psig steam and cooled with cooling water. The pipe reactor was rated for 150 psig. One end of the reactor was semi-permanently closed with a flat metal flange cover. The opposite end of the reactor was closed with a flat metal flange cover that was removable for loading and unloading wood for chemical treatment. The reactor volume was 35 gallons. Connected to a 1″ inlet nozzle was a liquid feed pump, so that acetic acid and/or acetic anhydride (or mixtures thereof) could be added by gravity from a heated tank on the building roof. Also connected to this feed nozzle was another feed system with a steam vaporizer, so that acetic anhydride or acetic anhydride/acetic acid mixture could be fed to the reactor as a vapor under positive pressure.

A 2″ vapor outlet nozzle at the opposite end of the reactor connected to a condenser and a condensate holding tank. The vent from the condensate holding tank passed through a control valve such that positive reactor pressure could be maintained and controlled. This vent could be valved such that it vented the system to the atmosphere or vented the system to a steam jet for pulling vacuum on the reactor. A valve in the reactor vapor line could be closed when desirable to place the reactor under positive pressure. Nitrogen at up to 100 psig could be fed to the reactor (through the vapor inlet nozzle) to pressurize the system.

Acetylation of Deck Boards: Three deck boards (nominal 5.5″×1″×96″) were placed in the unit. Vacuum (30-50 mmHg) was applied via the steam jet for 10-20 minutes to remove air from the boards. Glacial acetic acid was charged to the reactor under vacuum to completely submerge the boards. The vacuum was maintained for 10-20 minutes to completely de-aerate the boards. The vacuum was released with nitrogen, and the reactor was pressurized to 60-90 psig with nitrogen, and the boards were allowed to soak for 10-30 minutes. The acetic acid was then pumped from the unit.

The reactor was vented to the condenser and through it to atmospheric pressure. The pressure control valve was set to control reactor pressure at 10-40 psig. The reactor jacket was heated with steam. As the reactor was heating up, the reactor headspace was pressurized with nitrogen to 25-40 psig. Acetic acid was now fed from the continuous feed system to the vaporizer such that acid vapors entered the reactor to heat and maintained pressure in the reactor. As the acetic acid vapors heated the wood, water was driven from the boards along with some acetic acid. This vapor exited the reactor and was condensed. Samples of the overhead condensate were collected and analyzed to determine the water content over time to determine whether the wood has been sufficiently dried by the acetic acid vapors. Once the drying endpoint was reached, the acetic acid vapor feed was stopped. Steam to the jacket was stopped and cooling water was fed to the jacket.

The reactor pressure was reduced to atmospheric pressure. Various amount of vacuum may be applied to flash some acetic acid from the wood. Acetic anhydride or acetic anhydride/acetic acid was charged to the reactor to completely submerge the boards. This step may be carried out under vacuum or at atmospheric pressure. The reactor was pressurized to 60-90 psig with nitrogen and the boards were allowed to soak for 10-30 minutes to thoroughly impregnate with the anhydride. The acetic anhydride was then pumped from the unit.

The reactor vent valve was closed off from the condenser. The reactor jacket was heated with steam. As the reactor was heating up, the reactor headspace was pressurized with nitrogen to 15-30 psig. Acetic anhydride or acetic anhydride/acetic acid was fed from the continuous feed system to the vaporizer such that anhydride vapors entered the reactor to heat and increase pressure in the reactor. When the acetic anhydride vapors heated the wood to 50-90° C., several exothermic reactions begin, involving acetic anhydride with components in the wood (such as residual water; hydroxyl groups in the lignin, hemi-cellulose and cellulose). The wood temperature and reaction time was a sufficient indicator to determine when the acetylation reaction has progressed to a desirable endpoint.

### Wood Drying Post-Reaction

Once the reaction was complete, the wood temperature was 145-170° C., and the reactor pressure was 15-50 psig. The steam on the jacket was maintained. The valve in the reactor vapor line was opened to vent excess pressure of the reactor to reduce pressure to atmospheric. Vacuum was applied to the reactor to reduce the pressure to 30-60 mmHg. Most of the acetic anhydride and acetic acid present in the acetylated wood flashed off as the pressure was reduced. The wood temperature fell to 70-95° C. as a result of the flashing. The wood could be dried by holding in the reactor heated with steam and by passing a flow of nitrogen through the reactor. Alternatively, microwaves could be beamed into the reactor through a microwave launcher so that the microwaves heat the wood driving off acetic anhydride/acid. When the boards are free of acid and anhydride they are cooled slightly and removed. Results of this process are illustrated in Table 6.

TABLE 6

| Run Number | 7-1 | 7-2 | 7-3 | 7-4 | 7-5 |
|---|---|---|---|---|---|
| Number of | 3 | 3 | 3 | 3 | 3 |
| Boards | | | | | |
| Wt of | 13.5 | 15.7 | 13.6 | 12.9 | 14.9 |
| Boards, kg | | | | | |
| WPG | 24.2 | 19.3 | 24.8 | 24.9 | 27.4 |
| % Acetyl | 16.8 | 15.2 | 17.1 | 18.2 | 18.0 |

### Example 7

### Acetylation of Larger Boards

The reaction conditions of Example 6 are used on 2×6×18 inch boards, 1×5.5×48 inch boards, 1×5.5×96 inch boards, 4×4 96 inch boards, and 6×6×96 inches.

This invention can be further illustrated by the following examples of preferred embodiments thereof, although it will be understood that these examples are included merely for purposes of illustration and are not intended to limit the scope of the invention unless otherwise specifically indicated.

What is claimed is:

1. A method, comprising:
(a) impregnating the lignocellulosic material with a liquid comprising acetic acid to form an impregnated lignocellulosic material;
(b) contacting the impregnated lignocellulosic material from (a) with a vapor stream comprising acetic acid under conditions sufficient to acetylate at least some of the lignocellulosic material.

2. The method of claim 1, wherein the liquid in (a) further comprises water, acetic anhydride, xylene, methyl isobutyl ketone, an acetate ester or a combination of two or more of the foregoing.

3. The method of claim 1, wherein the lignocellulosic material is solid wood.

4. The method of claim 1, wherein the lignocellulosic material is Southern Yellow Pine or Radiata pine.

5. The method of claim 1, wherein the acetic acid vapor stream in (b) further comprises at least one azeotropic agent.

6. The method of claim 5, wherein at least one azeotropic agent is chosen from xylene, toluene, methyl isobutyl ketone, an acetate ester or a combination of two or more of the foregoing.

7. The method of claim 1, wherein the WPG lignocellulosic material has a WPG of 4-15% after (b).

8. The method of claim 1, wherein the WPG lignocellulosic material has a WPG of 8-35% after (d).

9. The method of claim 1, wherein the WPG in (b) is at least 25% the WPG in (d).

10. The method according to claim 1, wherein the WPG in (b) is at least 50% the WPG in (d).

11. The method according to claim 1, wherein the lignocellulosic material prior to the impregnating in (a) has a water content ranging from 1% to 20% by weight and the contacting in (b) is performed until the lignocellulosic material has a water content of less than or equal to 2% by weight.

12. The method according to claim 1, wherein the lignocellulosic material prior to the impregnating is an undried lignocellulosic material and the contacting in (b) is performed until the lignocellulosic material has a water content of less than or equal to 8% by weight.

13. The method according to claim 11 wherein the contacting in (b) is performed until the lignocellulosic material has a water content of less than about 1% by weight.

14. The method according to claim 12 wherein the contacting in (b) is performed until the lignocellulosic material has a water content of less than about 1% by weight.

15. The method according to claim 1, further comprising
(c) impregnating at least a portion of the contacted lignocellulosic material from (b) with a liquid comprising acetic anhydride; and
(d) contacting the impregnated lignocellulosic material in (c) with a vapor stream under conditions sufficient to increase the acetylation of the lignocellulosic material, wherein the vapor stream comprises acetic anhydride, acetic acid, or both acetic anhydride and acetic acid.

16. The method of claim 15, wherein the lignocellulosic material is solid wood.

17. The method of claim 15, wherein the lignocellulosic material is Southern Yellow Pine or Radiata pine.

18. The method of claim 15, wherein the acetic acid vapor stream in (b) further comprises at least one azeotropic agent.

19. The method of claim 15, wherein at least one azeotropic agent is chosen from xylene, toluene, methyl isobutyl ketone, an acetate ester or a combination of two or more of the foregoing.

20. The method of claim 19, wherein the WPG lignocellulosic material has a WPG of 4-15% after (b).

21. The method of claim 15, wherein the WPG lignocellulosic material has a WPG of 8-35% after (d).

22. The method of claim 15, wherein the WPG in (b) is at least 25% the WPG in (d).

23. The method according to claim 15, wherein the WPG in (b) is at least 50% the WPG in (d).

24. The method according to claim 15, wherein the lignocellulosic material prior to the impregnating in (a) has a water content ranging from 1% to 20% by weight and the contacting in (b) is performed until the lignocellulosic material has a water content of less than or equal to 2% by weight.

25. The method according to claim 15, wherein the lignocellulosic material prior to the impregnating is an undried lignocellulosic material and the contacting in (b) is performed until the lignocellulosic material has a water content of less than or equal to 8% by weight.

26. The method according to claim 24 wherein the contacting in (b) is performed until the lignocellulosic material has a water content of less than about 1% by weight.

27. The method according to claim 25 wherein the contacting in (b) is performed until the lignocellulosic material has a water content of less than about 1% by weight.

28. A lignocellulosic material made by the method of claim 1.

29. A lignocellulosic material made by the method of claim 15.
